(19) United States
(12) Patent Application Publication
(10) Pub. No.: US 2022/0156551 A1
(43) Pub. Date: May 19, 2022

(54) METHOD OF TRANSMITTING AND MERGING DATA

(71) Applicants: Inventec (Pudong) Technology Corporation, Shanghai (CN); INVENTEC CORPORATION, Taipei (TW)

(72) Inventors: Yu-Sheng Lin, Taipei (TW); Wei-Chao CHEN, Taipei (TW); Trista Pei-Chun CHEN, Taipei (TW)

(21) Appl. No.: 17/165,096

(22) Filed: Feb. 2, 2021

(30) Foreign Application Priority Data
Nov. 18, 2020 (CN) 202011293554.7

(51) Int. Cl. G06N 3/04; G06F 7/14; H04B 1/02; H04B 1/06

(52) U.S. Cl. CPC G06N 3/04; H04B 1/06; H04B 1/02; G06F 7/14

(57) ABSTRACT

A method of transmitting and merging data is adapted to a sender and a receiver that are in communication with each other. The method comprises a sending stage and a receiving stage. The sending stage comprises: transmitting a first block data, a second block data and a third block data to the receiver by the sender; obtaining a fourth block data and a fifth block data by the sender; and transmitting the third, fourth and fifth block data to the receiver by the sender. The receiving stage comprises: receiving the first, second, and third block data by the receiver; merging the first, second and third block data to perform a convolution operation by the receiver; receiving the third, fourth and fifth block data by the sender; and merging the third, fourth and fifth block data to perform another convolution operation.

### CROSS-REFERENCE TO RELATED APPLICATIONS

This non-provisional application claims priority under 35 U.S.C. § 119(a) on Patent Application No(s). 202011293554.7 filed in China on Nov. 18, 2020, the entire contents of which are hereby incorporated by reference.

### BACKGROUND

### 1. Technical Field

This disclosure relates to a convolution neural network accelerator, and more particularly to a method of dividing data for transmission and merging in a convolution operation using tiled processing.

### 2. Related Art

Convolutional neural networks (CNNs) are now considered one of the most widely used machine learning techniques in computer vision and image processing. Its primary operation is the convolution between kernels (weights) and feature maps (activations), which can consume lots of power through MAC operations and memory accesses.

Compared with the energy wasted through redundant operations, data access power is arguably more critical for future accelerator designs because memory bandwidth has been growing slower than the speed of PEs. That is, an algorithm can become increasingly memory bound for future architectures. Newer networks tend to adopt smaller convolution kernels with deeper layers, which further reduces operation count at the cost of increased memory usage. According to the statistics, accessing the feature map in Dynamic Random Access Memory (DRAM) consumes more power than other operations with the evolution of neural network model.

Current CNN generally adopts tiled processing, and that is, a processing element loads one block from an external storage device for an operation at a time. For example, the data block stored in the external storage device DRAM is directly loaded to a Static Random Access Memory (SRAM) near the processing element as a cache data without being compressed. However, the above method consumes considerable power and memory bandwidth when accessing DRAM for switching the processes data block. For example, the data stored in DRAM may be divided into multiple subtensors with the same size. These subtensors are compressed and then transmitted to SRAM for being decompressed. The processing element loads the required data block from SRAM for computation. Data block compression may save the power and memory bandwidth during data transmission. However, the SRAM may store the data that is not used in the current processing if the size of a subtensor is too large, and thus, the storage space of the SRAM is wasted. Furthermore, additional time is spent decompressing the file in a large size for obtaining complete block data, but only a small amount of data is required. On the other hand, if the size of a subtensor is too small, additional memory bandwidth is required to load a large quantity of pointers for decompressing the original data block in a correct order.

### SUMMARY

Accordingly, the present disclosure provides an efficient, hardware-friendly data storage scheme for sparse CNN feature maps. The present disclosure divides data into uneven-sized subtensors and stores them in a compressed yet randomly accessible format using few pointers. This design enables modern CNN accelerators to fetch and decompressed sub-tensors on-the-fly in a tiled processing manner. The present disclosure is suitable for architectures that favor aligned, coalesced data access, and only requires minimal changes to the overall architectural design.

According to one or more embodiment of this disclosure, a method of transmitting and merging data adapted to a sender and a receiver that are in communication with each other, wherein the method of transmitting and merging data comprises: a sending stage comprising: transmitting a first block data, a second block data and a third block data to the receiver by the sender; obtaining a fourth block data and a fifth block data by the sender; and transmitting the third block data, the fourth block data and the fifth block data to the receiver by the sender; and a receiving stage comprising: receiving the first block data, the second block data and the third block data by the receiver; merging the first block data, the second block data and the third block data to perform a convolution operation by the receiver; receiving the third block data, the fourth block data and the fifth block data by the sender; and merging the third block data, the fourth block data and the fifth block data to perform another convolution operation.

In view of the above, the present disclosure proposes an efficient storage scheme for sparse feature map for reducing external memory bandwidth, which is aligned to the memory access patterns in modern CNN accelerator architectures. Given a specific CNN layer and an accelerator configuration, the present disclosure may convert a sparse tensor into multiple subtensors with different sizes. Existing accelerators can be integrated with the present disclosure to improve an overall performance with a minimum of hardware modification and overhead.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart of the method of transmitting and merging data according to an embodiment of the present disclosure;

FIG. 2 is a schematic diagram of a feature map divided into multiple data blocks in a horizontal direction;

FIG. 3 is a schematic diagram of the first embodiment;

FIG. 4 is a partition schematic diagram of the input data;

FIG. 5 shows an example that a general convolution adopts a configuration of the present disclosure;

FIG. 6 shows an example that a dilated convolution adopts another configuration of the present disclosure; and

FIG. 7 shows an example of the storage of subtensors and pointers in the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The present disclosure is adapted to any field with convolution. The present disclosure proposes a method of transmitting and merging data, including a method of dividing an input feature map, which may prevent accessing partially compressed subtensors, and minimize the number of subtensors to prevent data fragmentation.

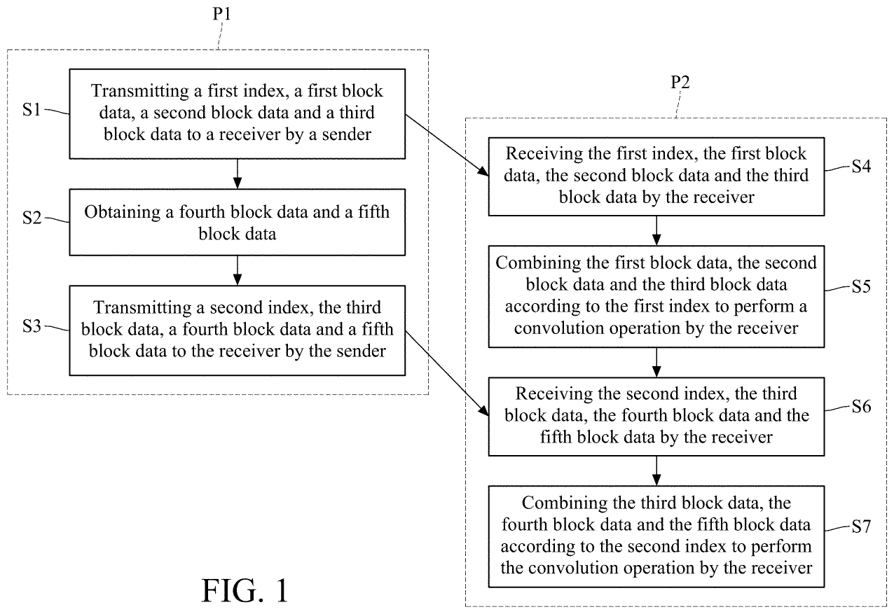

FIG. 1 is a flowchart of the method of transmitting and merging data according to an embodiment of the present disclosure. The method is adapted to a sender and a receiver that are in communication with each other. For example, the sender comprises an external storage device (e.g. DRAM) and a control circuit processing data partition, and the sender is a CNN accelerator including processing elements and a cache (e.g. SRAM).

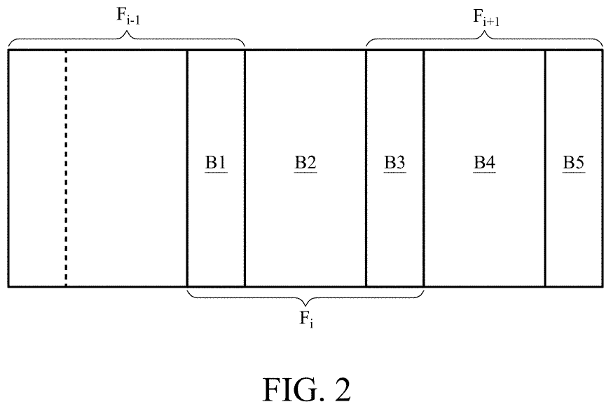

FIG. 2 is a schematic diagram of a feature map divided into multiple data blocks in a horizontal direction. Assuming that an input feature map F is processed in each operation of the CNN accelerator, the CNN accelerator processes the input feature map Fᵢ₋₁ in the (i−1)^{th} operation, processes the input feature map Fᵢ in the i^{th} operation, and processes the input feature map Fᵢ₊₁ in the (i+1)^{th} operation.

As shown in FIG. 1, the method of transmitting and merging data according to an embodiment of the present disclosure comprises a sender stage P1 and a receiver stage P2. The sender stage P1 comprises steps S1, S2 and S3 and the receiver stage P2 comprises steps S4, S5, S6 and S7.

Step S1 shows that “transmitting a first pointer, a first block data B1, a second block data B2 and a third block data B3 to the receiver by the sender”. In practice, before transmitting the first block data B1, the second block data B2 and the third block data B3 to the receiver by the sender, the method further comprises the step of compressing the first block data B1, the second block data B2 and the third block data B3 by a compressor, so as to reduce the bandwidth occupied during the transmission of the first block data B1, the second block data B2 and the third block data B3. The first pointer is configured to indicate a starting address of the first block data B1, a size of the first block data B1, a size of the second block data B2, and a size of the third block data B3.

Step S2 shows that “obtaining a fourth block data B4 and a fifth block data B5 by the sender”. Specifically, the control circuit of the sender can divide the consecutive three feature maps Fᵢ₋₁, Fᵢ and Fᵢ₊₁ that are adjacent to each other in space into the first block data B1, the second block data B2, the third block data B3, the fourth block data B4 and the fifth block data B5 according to an arrangement method described below.

Step S3 shows that “transmitting a second pointer, the third block data B3, the fourth block data B4 and the fifth block data B5 to the receiver by the sender”. In practice, before transmitting the third block data B3, the fourth block data B4 and the fifth block data B5 to the receiver by the sender, the method further comprises the step of compressing the third block data B3, the fourth block data B4 and the third block data B5 by a compressor, so as to reduce the bandwidth occupied during the transmission of the third block data B3, the fourth block data B4 and the fifth block data B5. The second pointer is configured to indicate a starting address of the third block data B3, the size of the third block data B3, a size of the fourth block data B4, and a size of the fifth block data B5.

Step S4 shows that “receiving the first pointer, the first block data B1, the second block data B2 and the third block data B3 by the receiver”. As shown in FIG. 1, step S4 is performed after step S1 is completed.

Step S5 shows that “merging the first block data B1, the second block data B2 and the third block data B3 to perform a convolution operation by the receiver according to the first pointer”. In practice, the method further comprises the step of decompressing the first block data B1, the second block data B2 and the third block data B3 by a decompressor before performing the convolution operation. These three pieces of block data B1-B3 are stored in SRAM after being decompressed. The processing element can obtain the first starting address of the first block data B1 in SRAM according to the first pointer, calculate the second starting address of the second block data B2 in SRAM according to the first starting address and the size of the first block data B1, and calculate the third starting address of the third block data B3 in SRAM according to the second starting address and the size of the second block data B2.

Step S6 shows that “receiving the second pointer, the fourth block data B4 and the fifth block data B5 by the sender”. As shown in FIG. 1, step S6 is performed after step S3 is completed.

Step S7 shows that “merging the third block data B3, the fourth block data B4 and the fifth block data B5 to perform another convolution operation according to the second pointer by the receiver”. In practice, the method further comprises step of decompressing the third block data B3, the fourth block data B4 and the fifth block data B5 by the decompressor before performing the convolution operation. These three pieces of block data B3˜B5 are stored in SRAM after being decompressed. The processing element may obtain the third starting address of the third block data B3 in SRAM according to the second pointer, calculate the fourth starting address of the fourth block data B4 in SRAM according to the third starting address and the size of the third block data B3, and calculate the fifth starting address of the fifth block data B5 in SRAM according to the fourth starting address and the size of the fourth block data B4.

As shown in FIG. 2, the present disclosure proposes a method for dividing the input feature maps Fᵢ₋₁, Fᵢ and Fᵢ₊₁. In the following, two embodiments are described for the detailed implementations of the division and arrangement of the feature maps. In the first embodiment, real numbers are used for illustration, and in the second embodiment, variables are used to illustrate a general implementation of the present disclosure.

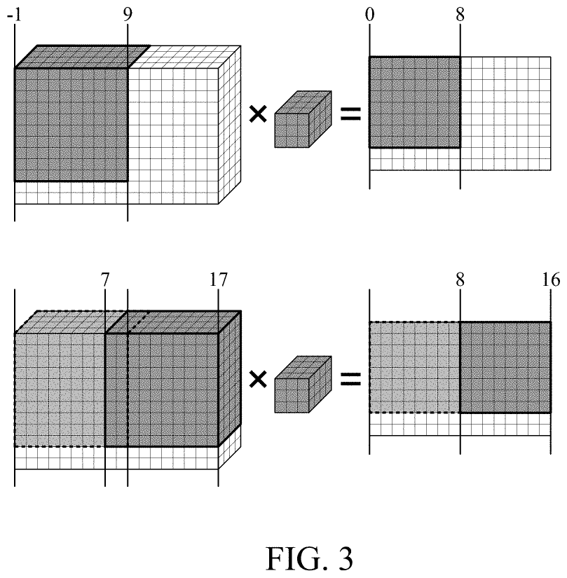

FIG. 3 is a schematic diagram of the first embodiment. For example, in the CNN architecture, a 3×3 kernel convolution is processed, a 8×8 tile size is used for the output feature map, and zero-padding is adopted so that the output feature map has the same size of the input feature map.

In the first-time processing, the proposed method fetches a 10×10 input tile from the left corner of the input feature map. As shown in FIG. 1, the left boundary is −1, and the right boundary is 9 in a horizontal direction.

In the second-time processing, the proposed method steps forward the right by 8 elements on the feature map to fetch the next input tile.

Since the step size is constant within one layer of CNN processing, the left boundaries and the right boundaries of input tiles fetched every time form two arithmetic progression, denoted as Bₗ={−1, 7, 15, . . . } and Bᵣ={9, 17, 25, . . . }, wherein Bₗ represents the left boundary and Bᵣ represents the right boundary. The arrangement proposed by the present disclosure is the division formed by these two boundaries, namely the union, G=Bₗ∪Bᵣ. In this example, G={1, 7} (mod 8).

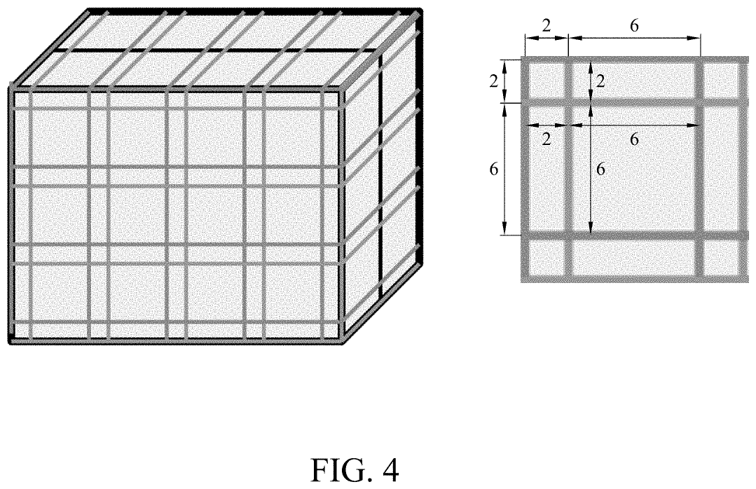

Because 7−1=6 (mod 8), 1−7=2 (mod 8), and the arrangement described above is adapted to the division in a horizontal direction or in a vertical direction, each input feature map may be divided into two uneven sizes of 2 and 6, which results in four subtensor shapes: 6×6, 2×6, 6×2, and 2×2. FIG. 4 is a partition schematic diagram of the input data.

A 10×10 window is then composed of one 6×6, two 2×6 and 6×2, and four 2×2 subtensors.

In addition, since the halo only appears in the spatial dimension, this division process is not necessary along the channel dimension.

The second embodiment will be described below. In this embodiment, computation of every layer of CNN may be defined with the following parameters:

Kernel size is denoted as 2k+1 since kernel size tends to be odd integers.

Two output elements convolving two windows with a stride of s. When s>1, it means a smaller output feature map and thus less computation cost.

Dilated CNN convolves strided input elements for one output element to enlarge the equivalent window size, and the present disclosure denotes this stride as d.

The output tile size is denoted as tₕ×t_{w}.

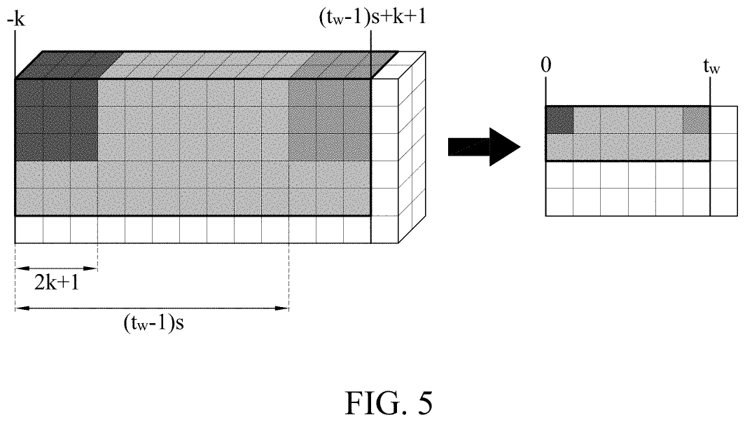

Based on the above representatives of parameters, FIG. 5 shows an example of a general convolution adopting an configuration, (k, s, d, =(1, 2, 1, 6), of the present disclosure. To compute the leftmost output element, the present fetches from the feature map a window starting at the left boundary of −k and right boundary of (t_{w}−1)s+k+1. Since the offset between two neighboring subtensors is st_{w}, the arrangement may be defined as follows.

$$G = \{ - k , ( {t}_{w} - 1 ) s + k + 1 \} ( mod {st}_{w} ) = \{ - k , k - s + 1 \} ( mod {st}_{w} )$$

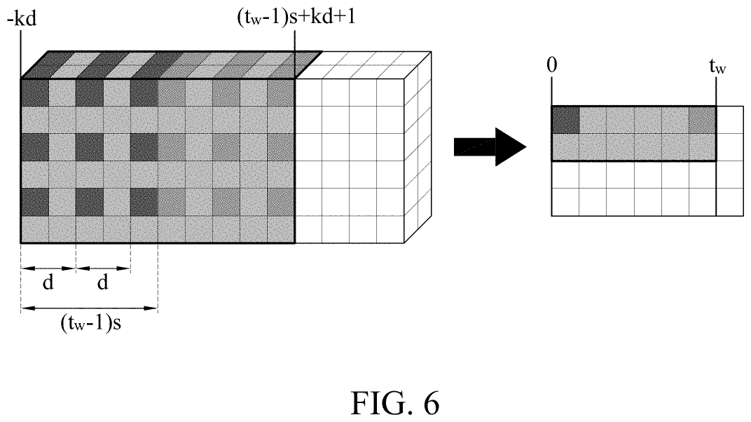

FIG. 6 shows an example that a dilated convolution adopts another configuration of the present disclosure, (k, s, d, t_{w})=(1, 1, 2, 6).

For dilated CNN shown in FIG. 6, a similar process yields another arrangement as follows.

G={−kd,kd−s+1}(mod st_{w})

According to the aforementioned arrangements proposed by the present disclosure, it can be noticed that the configuration for mod N is also valid for mod N′ when N is divisible by N′ (N′|N).

Taking AlexNet CONV1 as an example, whose configuration, (k, s, t_{w})=(5, 4, 8), corresponds to a configuration, G1={27, 2} (mod 32), of the present disclosure. Therefore, another configuration, G2={3, 2} (mod 8), is also valid to AlexNet CONV1.

It is thus possible to use a single N across all CNN layers to keep the hardware implementation simple, and in an embodiment of the present disclosure, N=8 can be a suitable choice for most cases.

Multiple subtensors divided according to a given configuration of the present disclosure have to be stored in a data structure that complies the memory alignment requirement to maximize the benefits of compression. Since subtensors may have different compressed size, the present disclosure has to store the extra pointers separately from the compressed subtensors.

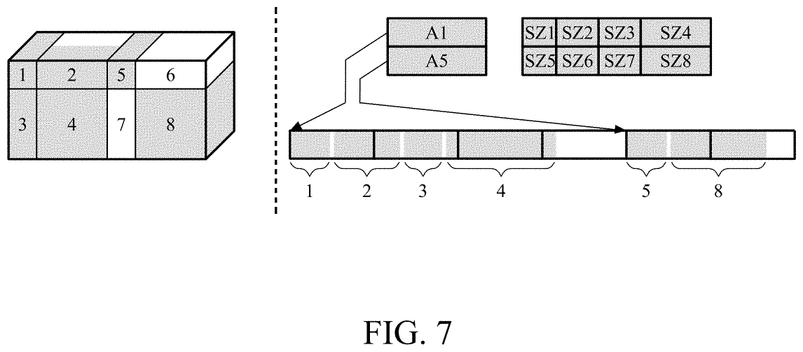

FIG. 7 shows an example of the storage of subtensors and pointers in the present disclosure. Regarding adjacent subtensors such as subtensors 1, 2, 3 and 4 shown in FIG. 7, the present disclosure only uses a pointer A1 to indicate the starting address of block 1 and uses pointers SZ1-SZ4 to indicate compressed sizes of these four subtensors respectively. Thus, accessing these subtensors is a two-step procedure, where the present disclosure first locates the starting address from the pointer A1, and then adds the subtensor sizes to get the actual offset for each subtensor.

Because the pointer of the present disclosure has not to correspond to each subtensor, the total size of pointers may be effectively reduced.

The present disclosure proposes a hardware-friendly method for storing and accessing compressed, sparse feature maps. The present disclosure divides the feature maps into uneven subtensors, and in the process, avoids wasteful fetches of partial subtensors and partial cache lines. Furthermore, the present disclosure only requires a small metadata indexing overhear to keep track of the locations of the compressed subtensors. The present disclosure can be a simple-yet-effective modification for existing CNN accelerators since it is mostly independently of the compression algorithms and requires changes only to the existing feature map division methods. The present disclosure can save a large amount memory bandwidth during the data transmission.

In view of the above, the present disclosure proposes an efficient storage scheme for sparse feature map for reducing external memory bandwidth, which is aligned to the memory access patterns in modern CNN accelerator architectures. Given a specific CNN layer and an accelerator configuration, the present disclosure may convert a sparse tensor into multiple subtensors with different sizes. Existing accelerators can be integrated with the present disclosure to improve an overall performance with a minimum of hardware modification and overhead.

What is claimed is:

1. A method of transmitting and merging data adapted to a sender and a receiver that are in communication with each other, wherein the method of transmitting and merging data comprises:
a sending stage comprising:
transmitting a first block data, a second block data and a third block data to the receiver by the sender;
obtaining a fourth block data and a fifth block data by the sender; and
transmitting the third block data, the fourth block data and the fifth block data to the receiver by the sender; and
a receiving stage comprising:
receiving the first block data, the second block data and the third block data by the receiver;
merging the first block data, the second block data and the third block data to perform a convolution operation by the receiver;
receiving the third block data, the fourth block data and the fifth block data by the sender; and
merging the third block data, the fourth block data and the fifth block data to perform another convolution operation.

2. The method of transmitting and merging data of claim 1, further comprising:
transmitting a first pointer to the receiver by the sender when transmitting the first block data, the second block data and the third block data to the receiver;
wherein the first pointer is configured to indicate a starting address of the first block data, a size of the first block data, a size of the second block data, and a size of the third block data; and
transmitting a second pointer to the receiver by the sender when transmitting the third block data, the fourth block data and the fifth block data to the receiver;
wherein the second pointer is configured to indicate a starting address of the third block data, a size of the third block data, a size of the fourth block data, and a size of the fifth block data.

3. The method of transmitting and merging data of claim 1 further comprising:
compressing the first block data, the second block data and the third block data by a compressor before transmitting the first block data, the second block data and the third block data to the receiver by the sender;
compressing the third block data, the fourth block data and the fifth block data by the compressor before transmitting the third block data, the fourth block data and the fifth block data to the receiver by the sender;
decompressing the first block data, the second block data and the third block data by a decompressor before merging the first block data, the second block data and the third block data to perform the convolution operation by the receiver; and
decompressing the third block data, the fourth block data and the fifth block data before merging the third block data, the fourth block data and the fifth block data to perform said another convolution operation.
